(19) United States
(12) Patent Application Publication
(10) Pub. No.: US 2019/0226249 A1
(43) Pub. Date: Jul. 25, 2019

(54) APPARATUS FOR INFLUENCING THE MOVABILITY OF A DOOR

(71) Applicant: Witte Automotive GmbH, Velbert (DE)

(72) Inventors: Christian Zammert, Wuppertal (DE); Michael Linner, Essen (DE); Janosch Jordan, Essen (DE)

(21) Appl. No.: 16/320,020

(22) PCT Filed: Jul. 21, 2017
(86) PCT No.: PCT/EP2017/068478

§ 371 Date: Jan. 23, 2019

(30) Foreign Application Priority Data
Jul. 25, 2016 (DE) 10 2016 113 696.4

(51) Int. Cl. E05C 17/20; E05C 17/00

(52) U.S. Cl. CPC E05C 17/203; E05C 17/006

(57) ABSTRACT

The invention relates to an apparatus for influencing the movability of a door which can be moved between a closed position and an open position, in particular of a motor vehicle, which apparatus comprises a sensor system for determining the door position and/or the door moving speed, an actuating device for setting a resistance to movement of the door, and a control device for controlling the actuating device as a function of the determined door position and/or the door moving speed.

The present invention relates to an apparatus for influencing the movability of a door, in particular of a motor vehicle, movable between a closed position and an open position.

Apparatus for influencing the movability of a door are generally known. So-called door check straps have thus in particular become established in the automotive sector that are intended to prevent a movement of the door that is too free and is therefore difficult to control by means of an adaptive mechanical connection between the door and the fixed-position door pillar or door frame. A self-activating movement of the door should in particular be avoided where possible. Known door check straps frequently comprise a so-called catch strap that is e.g. rotatably anchored at a door pillar and in dependence on the door position is sectionally pushed into an opening of the door where a braking element engages at the catch strap to increase the movement resistance of the door.

One problem of such door check straps is that they have to be matched to the respective door weight and door geometry to achieve a desired movability of the door, in particular a desired movement resistance. The corresponding adaptation effort is, however, unwanted in view of ever shorter development times.

Another problem is that the desired movability of the door is only achieved when e.g. the respective vehicle is not on an incline. If the vehicle is, however, inclined, e.g. due to parking half on a raised sidewalk, the movability can differ from the desired movability due to the door's own weight that can become severe due to the inclination. Depending on the side of the vehicle, this has the result that the door can be controlled by the user with greater difficulty or can only be moved with an increased effort. Such scenarios naturally have to be considered in the design of a door check strap, which makes complex modifications of the door check strap necessary in individual cases.

The known door check straps are furthermore subject to wear that can produce a change in the desired movability, in particular a reduction of the resistance to movement. Under certain circumstances the door can hereby become much more difficult to control, which correspondingly increases the risk of an unwanted collision of the door with obstacles, e.g. with a nearby vehicle.

The incalculable factors with respect to the actually present movability of the door caused by wear, vehicle inclination, or other factors of influence (e.g. temperature, lubricant depletion) should be at least partly compensated by so-called latch points of the door. These latch points represent discrete door positions between the closed position and the maximum open position from which the door can only be moved out of with an increased effort or into which the door can only conversely be moved with increased force. A respective latch point therefore represents a “catch point” for the door that should prevent uncontrolled door movements for reasons of comfort and safety. Although a respective latch point can as a rule satisfy this function, it is nevertheless disadvantageous that the latch points have to be fixed again for every new vehicle in dependence on the door size and on the pivot range of the door. Apart from this, vehicle users repeatedly report that they find the fixedly coded latch points irritating, either due to the local difficult motion of the door or to the position of the latch points that are outside a door position range required as a rule for getting into and out of the vehicle.

It is an object of the invention to provide an apparatus for influencing the movability of a door by which the described disadvantages are eliminated. The object of the invention also extends to a corresponding method.

An apparatus in accordance with the invention comprises a sensor system for determining the door position and/or the door movement speed, a setting device for setting a movement resistance of the door, and a control device for controlling the setting device in dependence on the determined door position and/or door movement speed. In other words, an electromechanical apparatus is provided with which the movement resistance can be variably set in dependence on at least one determined door parameter—the door position and/or the door speed. The door can thus be provided in a simple manner with respective desired resistance characteristics that can in particular be flexibly adapted to the needs of the user and that can be optimized in this respect to achieve a high user quality. A complex design of a conventional door check strap with which a more or less satisfactory compromise in matters of user quality should be achieved is no longer required. It is in particular possible by means of the apparatus in accordance with the invention to ensure a movability of the door that always remains the same, with factors of influence (vehicle inclination, wear, etc.) that had previously caused an unwanted change of the targeted movability being able to be reliably compensated.

Advantageous embodiments of the invention can be seen from the dependent claims, from the description, and from the drawing.

“Influencing the movability” is understood within the framework of this disclosure not only as a braking of the moving boor, but also as a checking or stopping of the door. In the latter case, the set movement resistance can be so high that the user can practically no longer move the door. The principle generally underlying the invention is that the door movability is actively influenced by the control device and the setting device connected thereto, either due to a determined door position and/or due to the determined door movement speed. In the case of a dependence on the door movement speed, a position of rest of the door (speed equal to zero) brought about by the user can, for example, be recognized, whereupon the movement resistance is set such that a self-activating movement of the door is prevented. The movability can furthermore be differently influenced depending on the door position. For example, the movement resistance from the closed position toward the completely open position can be increased gradually (linearly or non-linearly) or can be varied only sectionally. It is furthermore conceivable that the degree of influence on the movability is proportional to the door movement speed. Too fast a movement, i.e. an uncontrolled movement, of the door by the user can thus be countered.

Some details of technical implementation options of the invention will be explained in the following.

The apparatus can generally be used for all conceivable door types, in particular for swing doors, sliding doors, and combinations thereof. These doors are preferably manually movable between the closed position and the open position. The door can be movable additionally, in particular to support a manual movement, or alternatively by an electric motor. Depending on the type of door, the sensor system can comprise at least one sensor for detecting a pivot angle position of the door and/or for detecting a sliding position location of the door. In particular a linear path sensor can be provided for this purpose. Such a path sensor can determine, e.g. in the case of a swing door, how far a catch strap connecting the door and the door pillar projects into the door. A conclusion can then be drawn on the corresponding pivot angle position from this information.

It is understood that the pivot angle position or the sliding position location does not have to be able to be determined in every situation. Provision can thus be made, for example, that only one or more discrete door positions can be determined, i.e. only individual door locations spaced apart from one another can be detected, e.g. by means of electric contact switches.

The determination of the door position and/or of the door speed is to be understood in the sense of a determination of a primary target value with reference to which the movement resistance is set. The fact thus does not stand in the way of determining the door speed that two or more door positions detected after one another can be used for this purpose within the sensor system. It is rather a question of the specific reference value with reference to which the movement resistance is set. In addition to a taking into account of one or more door positions or of the door movement speed, the determination of the door acceleration that can e.g. be calculated from two door movement speeds determined after one another is also conceivable.

The sensor can be a force sensor, an inductive sensor, a capacitance sensor, a Hall sensor, an optical sensor or a gyroscope. Angular position sensors (rotary encoders) such as incremental encoders known for determining the pivot angle position can in particular be used in dependence on the specific measurement purpose and on the measurement environment. Alternatively or additionally, a contact pressure of the catch strap on the sensor dependent on the door position can be determined by means of a force sensor. A conclusion can then be drawn on the door position on the basis of the determined contact pressure. In particular an induction-to-digital converter (LDC) sensor (e.g. LDC 1612/1614) can be considered for the inductive sensor that is, for example, arranged such a spacing between the sensor and the catch strap can be determined that is dependent on the door position. A differential transformer and metrologically related sensors are also conceivable as sensors. Suitable gyroscopes can furthermore be used, in particular MEMS (MicroElectroMechanical System) gyroscopes, that are available at favorable prices and that enable a particularly compact design of the apparatus.

The setting device can comprise at least one braking means, with the movement resistance of the door being settable by a suitable positioning of and/or pressure application on the braking means. The braking means can in particular be of a mechanical nature and can, for example, be equipped with a braking element whose contact pressure on a catch strap of the door can be varied by the setting device. Alternatively or additionally, however, braking means are also conceivable that can be acted on electromagnetically and by which the movement resistance of the door can in particular be varied without contact and thus with low wear. The setting device can also comprise stopping means to check the door such as an adjustable stopping element, in particular a pin. It is understood that the stopping means for the checking of the door can also be formed by the braking means themselves. The braking force can be increased so much in this respect that the door is practically stopped.

In accordance with an embodiment, a selectively definable end position can be provided for the door, with the control device being adapted to control the setting device such that a movement of the door beyond the end position is prevented. The end position can in particular be different from the mechanically limited maximum open position of the door (end abutment). The maximum pivot angle range or sliding range of the door can thus be limited without a mechanical end abutment having to be provided for this purpose. The end abutment perceived by the user as part of a door movement can therefore merely be simulated in that the door is braked so much or is stopped on a reaching of the door position defined as the end position that a further pivoting or a further sliding of the door is prevented. The end position can e.g. be stored as an associated pivot angle value or sliding position value in a memory or the control device and can in particular be set by the user.

In accordance with a further embodiment, on or more selectively definable latch points for the door can be provided, with the control device being adapted to control the setting device such that a movement of the door is made more difficult at a latch point. A respective freely definable latch point can therefore represent a door position between the maximum open position and the closed position of the door in which a mechanical latch point is simulated. The subjective impression of a mechanical latch point can in particular be created here solely by setting a suitable resistance characteristic. This resistance characteristic can be restricted as with a mechanical latch point to the direct environment around the latch point, i.e. the movement resistance is still relatively small directly at the latch point, but increases by equal amounts locally in both directions of movement. However, it is possible to deviate from such a known resistance characteristic due to the freedoms of a programmable control device. For example, only a single “resistance threshold” can be provided at the latch point. Alternatively, two differently configured resistance thresholds can e.g. be provided around the latch point so that, for instance, a closing movement of the door from a latch point is easier for a user than an opposite opening movement. Such a resistance characteristic in dependence on the movement direction can naturally also be implemented with only one single resistance threshold since it can be flexibly adapted. It is furthermore conceivable to design a latching of the door at a latch point as less jerky in comparison with conventional mechanical latch points, for example by a resistance threshold stretched further over the movement range of the door and/or by taking the door movement speed into account. At a high door movement speed, the door can be braked more at the latch point than at a low door movement speed. The door movability that is felt to be jerky with conventional door check straps by some users can thus be eliminated in favor of latch points that act in a manner adapted to the situation, which can in particular noticeably increase user comfort with heavy doors.

In accordance with a further embodiment, the control device is adapted to control the setting device such that the door is braked before reaching a predetermined door position, in particular the closed position. Unwanted consequences of a “door slamming” such as an excessive load on the door or on the door frame or an acoustic nuisance for vehicle occupants can hereby be effectively avoided. The braking of the door in the sense of such a “soft close” function can naturally also be applied to the maximum open position of the door, in particular to the end position of the door observed by the apparatus. I.e. the door is braked before reaching the end position, whereby in particular a rebounding of the door is avoided. It is understood that the door can only be braked directly before reaching the closed position or the end position, with the braking power being able to be adapted to the determined door speed. It is, however, also conceivable that the door is increasingly braked over a wide movement range up to the end position. The ideal resistance characteristic can preferably be determined using subjective tests so that a closing of the door that is as smooth as possible is in particular ensured with a simultaneously high sense of quality. It may have to be considered here whether the door has an electrical closing mechanism or closing aid that closes the door in a self-activating manner directly before reaching the closed position, e.g. by means of an electric claw.

The control device can furthermore be adapted to control the setting device such that the movement speed of the door is restricted to a predefined value. A corresponding regulation of the setting device by the control device can in particular be configured as threshold-based, e.g. in that the movement resistance is only increased so much directly before reaching the predefined maximum speed that the latter is not exceeded. In addition, the movement resistance can be gradually increased below the maximum speed so that the subjective impression of a regulation suddenly intervening in the movement process in the sense of an “electronic nanny” is avoided.

In accordance with a further embodiment, the apparatus comprises at least one obstacle sensor for detecting obstacles in the movement range of the door. The control device can be adapted in this respect to control the setting device such that an unwanted collision between the door and a detected obstacle is avoided. The obstacle sensor can in particular be arranged in the outer door handle and can determine the distance between the door and potential obstacles by means of contactless sensor technologies (e.g. electromagnetically or optically). Ultrasonic sensors, laser sensors, and radar sensors as well as cameras can in particular be considered. Such sensors can e.g. be installed as side, front or rear parking sensors and can also be used for the purpose of obstacle detection for the door pivoting range. It is understood that a plurality of sensor signals from different obstacle sensors can be evaluated together to ensure a particularly reliable obstacle detection.

The setting device can be set such that the movement resistance is noticeably increased on a falling below of a safety distance between the door and the obstacle The user can thus be permitted to continue to move the door further in the direction of the obstacle while using increased effort. This can e.g. be necessary if the user wants to open the door to the maximum to be able to get out of the door at all. A stopping of the door despite a still present “collision-free” movement range is therefore not the aim. The movability is rather only made more difficult, whereby the user can control the door movement particularly simply. The door can, however, naturally also be stopped if this is desired.

The door movement speed can also be taken into account in addition to the current door position to adapt the movement resistance of the door in dependence on detected obstacles. In general, signals of the sensor system can be combined with signals of at least one obstacle sensor and can be supplied to a common evaluation (“sensor fusion”) to be able to set the movement resistance optimally).

At least the sensor system and the setting device can be accommodated in a common housing, whereby a compact module results that is in particular sealed with respect to external influences and that can be advantageously installed between an inner trim and an outer side of the door. An installation at the inner side of a door pillar is also conceivable. The control device can likewise be accommodated in the housing. Alternatively, the work of the control device can be satisfied by a control device that is arranged centrally in the car and that is connected to the apparatus for this purpose.

The apparatus or parts thereof, in particular the sensor system, the adjustment device, and the control device, can be connected a vehicle bus (e.g. a CAN (controller area network) bus or a LIN (local interconnected network) bus) to operate the apparatus. In this manner, vehicle operating information, in particular also signals from possible obstacle sensors, can be taken into account in the operation of the apparatus.

The invention generally relates to those doors that are manually pivoted or pushed by a user. It thus starts from an active or passive user behavior, with an active user behavior corresponding to a manual movement of the door and a passive user behavior corresponding to a refraining from a manual movement. With respect to the movability of the door perceptible by the user, the apparatus in accordance with the invention intervenes in the movability of the door as a response to the active or passive user behavior. The apparatus is therefore to be distinguished from fully automatic doors that are traveled between the closed position and the open position without the action of a user.

The apparatus can advantageously be installed in a motor vehicle having at least one door movable between a closed position and an open position. In particular the side doors, the tailgate, and the hood can be considered as doors of the motor vehicle.

The invention further relates to a method of influencing the movability of a door movable between a closed position and an open position, in particular by means of an apparatus in accordance with one of the above-described embodiments, said method comprising the door position and/or the door movement speed being determined by mans of a sensor system and the movement resistance of the door being set by means of a setting device in dependence on the door position and/or on the door movement speed.

The method in accordance with the invention can be expanded to include the method steps disclosed in connection with the embodiments of the apparatus. A movement of the door beyond a selectively definable end position can in particular be prevented. A movement of the door around a freely definable latch point can furthermore be made more difficult. The door can furthermore be braked before a reaching of a predefined door position, in particular the closed position. It is also possible that the movement speed of the door is restricted to a predefined value. A further advantageous embodiment of the method comprises obstacles in the movement range of the door being detected and an unwanted collision between the door and a detected obstacle being avoided. A material advantage of the invention is disclosed in this respect in that the movability of the door can always be set intelligently and in a manner adapted to the situation without causing the impression of a jerky door with a difficult motion or a smooth motion.

The invention will be described in the following purely by way of example with reference to the drawing in which

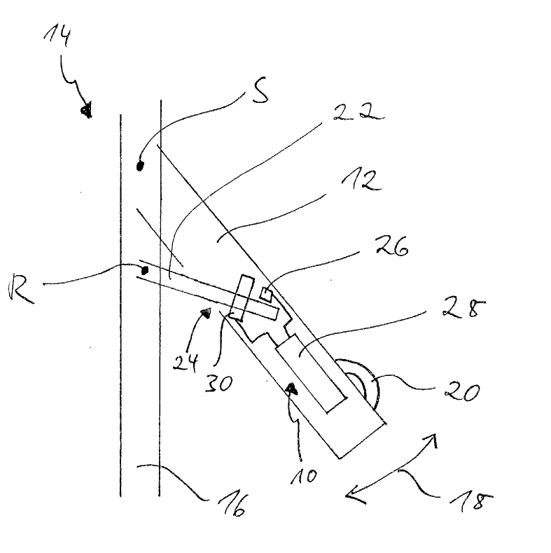

FIG. 1 shows a block diagram of an apparatus in accordance with the invention.

FIG. 1 shows an apparatus 10 for influencing the movability of a door 12 of a vehicle 14 that is indicated in FIG. 1 by a body section 16 associated with the door 12. The apparatus 10 is arranged in an inner region of the door 12. The door 12 is pivotably supported about a pivot axis S extending perpendicular to the plane of the paper and is movable between a closed position in which the door 12 is substantially in parallel with the body section 16 and a maximum open position (cf. direction of movement 18). In FIG. 1, the door 12 has adopted a door position between the closed position and the maximum open position. The door 12 is manually movable by a user, not shown, of the vehicle 14, for instance by actuation of a door outer handle 20.

The door 12 is coupled to a catch strap 22 that is pivotably supported about a pivot axis R. The catch strap 22 engages more or less far through an opening 24 of the door 12 in dependence on the pivot angle position of the door 12, with the relative position of the catch strap 22 being able to be determined by a sensor 26 that is connected to a control device 28. The sensor 26 and the control device 28 belong to the apparatus 10.

The corresponding pivot angle position of the door 12 is also known through the position of the catch strap 22 determined by the sensor 26. The control device 28 is adapted to control a setting device 30 in dependence on the pivot angle position of the door 12. The setting device 30 likewise belongs to the apparatus 10 and sets the movement resistance of the catch strap 22 and thus also the movement resistance of the door 12. The setting device 30 can also have means for a mechanical guiding of the catch strap 22. The control device 28 is furthermore adapted to determine a door movement speed from a plurality of determined pivot angle positions of the door 12 and to control the setting device 30 in dependence on the determined door movement speed.

### REFERENCE NUMERAL LIST

10 apparatus

12 door

14 vehicle

16 body section

18 direction of movement

20 door outer handle

22 catch strap

24 opening

26 sensor

28 control device

30 setting device

1.-11. (canceled)

12. An apparatus for influencing the movability of a door, the door being movable between a closed position and an open position, said apparatus comprising:
a sensor system for determining at least one of a door position and a door movement speed, with the sensor system comprising at least one sensor for detecting at least one of a pivot angle position of the door and a sliding position location of the door, and with the sensor being one of a force sensor, an inductive sensor, a capacitance sensor, a Hall sensor, an optical sensor, and a gyroscope;
a setting device for setting a movement resistance of the door; and
a control device for controlling the setting device in dependence on at least one of the determined door position and the door movement speed.

13. The apparatus in accordance with claim 12,
wherein the door is a motor vehicle door.

14. The apparatus in accordance with claim 12,
wherein the setting device has at least one braking means, with the movement resistance of the door being settable by a positioning of and/or pressure application on the braking means.

15. The apparatus in accordance with claim 12,
further comprising a selectively definable end position for the door,
with the control device being adapted to control the setting device such that a movement of the door beyond the end position is prevented.

16. The apparatus in accordance with claim 12,
further comprising one or more selectively definable latch points for the door, with the control device being adapted to control the setting device such that a movement of the door at a latch point is prevented.

17. The apparatus in accordance with claim 12,
wherein the control unit is adapted to control the setting device such that the door is braked before a reaching of a predefined door position.

18. The apparatus in accordance with claim 17,
wherein the predefined door position is the closed position of the door.

19. The apparatus in accordance with claim 12,
wherein the control device is adapted to control the setting device such that the movement speed of the door is restricted to a predefined value.

20. The apparatus in accordance with claim 12,
further comprising at least one obstacle sensor for detecting obstacles in the movement range of the door,
with the control device being adapted to control the setting device such that an unwanted collision between the door and a detected obstacle is avoided.

21. The apparatus in accordance with claim 20,
wherein the obstacle sensor is arranged in an outer door handle of the door.

22. The apparatus in accordance with claim 12,
wherein at least the sensor system and the setting device are accommodated in a common housing.

23. A motor vehicle having at least one door movable between a closed position and an open position and having an apparatus for influencing the movability of the door, said apparatus comprising:
a sensor system for determining at least one of a door position and a door movement speed, with the sensor system comprising at least one sensor for detecting at least one of a pivot angle position of the door and a sliding position location of the door, and with the sensor being one of a force sensor, an inductive sensor, a capacitance sensor, a Hall sensor, an optical sensor, and a gyroscope;
a setting device for setting a movement resistance of the door; and
a control device for controlling the setting device in dependence on at least one of the determined door position and the door movement speed.

24. A method of influencing the movability of a door movable between a closed position and an open position,
wherein
at least one of the door position and the door movement speed is determined by means of a sensor system; and
the movement resistance of the door is set by means of a setting device in dependence on the door position and/or on the door movement speed.

25. The method in accordance with claim 24, said movability being influenced by means of an apparatus, said apparatus comprising:
the sensor system for determining at least one of a door position and a door movement speed, with the sensor system comprising at least one sensor for detecting at least one of a pivot angle position of the door and a sliding position location of the door, and with the sensor being one of a force sensor, an inductive sensor, a capacitance sensor, a Hall sensor, an optical sensor, and a gyroscope;
the setting device for setting a movement resistance of the door; and
a control device for controlling the setting device in dependence on at least one of the determined door position and the door movement speed.
